(19) United States
(12) Patent Application Publication
(10) Pub. No.: US 2025/0386368 A1
(43) Pub. Date: Dec. 18, 2025

(54) TECHNIQUES FOR ENHANCING TIME DIVISION MULTIPLEXING AND FREQUENCY DIVISION MULTIPLEXING OPERATION FOR SIDELINK-UNLICENSED COMMUNICATIONS

(71) Applicant: QUALCOMM Incorporated, San Diego, CA (US)

(72) Inventors: Giovanni CHISCI, San Diego, CA (US); Chih-Hao LIU, San Diego, CA (US); Jing SUN, San Diego, CA (US); Xiaoxia ZHANG, San Diego, CA (US); Yisheng XUE, San Diego, CA (US); Stelios STEFANATOS, San Diego, CA (US)

(21) Appl. No.: 18/881,728

(22) PCT Filed: Jul. 12, 2023
(86) PCT No.: PCT/US2023/070081

§ 371 Date: Jan. 6, 2025

(30) Foreign Application Priority Data
Aug. 12, 2022 (GR) 20220100685

(51) Int. Cl. H04W 74/0808; H04W 16/14

(52) U.S. Cl. CPC H04W 74/0808; H04W 16/14

(57) ABSTRACT

Aspects of the present disclosure are directed to techniques to ensure that other UEs that may have reserved resources within the same resource selection window are allowed (or at least not prevented) from gaining access to the shared channel during their respective reserved resource period for both Out-of-COT and in-COT preemption window period.

### CROSS REFERENCE TO RELATED APPLICATION(S)

This application is a 35 U.S.C. § 371 National Stage Application of International Patent Application No. PCT/US2023/070081, filed Jul. 12, 2023, entitled “TECHNIQUES FOR ENHANCING TIME DIVISION MULTIPLEXING AND FREQUENCY DIVISION MULTIPLEXING OPERATION FOR SIDELINK-UNLICENSED COMMUNICATIONS” which claims the benefit of Greek patent application Ser. No. 20/220,100685, entitled “TECHNIQUES FOR ENHANCING TIME DIVISION MULTIPLEXING AND FREQUENCY DIVISION MULTIPLEXING OPERATION FOR SIDELINK-UNLICENSED COMMUNICATIONS” and filed on Aug. 12, 2022, which are assigned to the assignee hereof, and incorporated herein by reference in their entireties.

### BACKGROUND

### Technical Field

The present disclosure generally relates to communication systems, and more particularly, to techniques for enhancing time division multiplexing (TDM) and frequency division multiplexing (FDM) operation for sidelink-unlicensed (SL-U) communications for shared spectrum.

### Introduction

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard.

Therefore, there exists a need for further improvements in 5G NR technology. These improvements may also be applicable to other multi-access technologies and the telecommunication standards that employ these technologies. For instance, improvements to efficiency and latency relating to mobility of user equipments (UEs) communicating with network entities are desired.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Aspects of the present disclosure are directed to techniques to ensure that other user equipments (UEs) that may have reserved resources within the same resource selection window and/or a high-priority traffic are allowed (or not prevented) from gaining access to the shared channel during their respective reserved resource period for both Out-of-channel occupancy time (COT) and in-COT preemption window period due to the resource selection and transmission of a transmitter UE.

Particularly, in some instances, the transmitter UE (e.g., Tx UE) may select a plurality of resources within a resource selection window for sidelink communication with the receiver UE (e.g., Rx UE) such that the access of any other UEs, particularly of a higher priority UE than the first UE, in the shared channels are not impacted. Thus, in some instances, if a resource candidate selection would risk blocking a high-priority transmission from another UE (within preemption window T) that has already made its resource reservations, the Tx UE may adjust the selection of the plurality of resources within the resource selection window to be aligned with the one of the other reserving UEs. As such, the Tx UE listen-before-talk (LBT) procedure or transmission would not adversely impact the performance of other UEs on the shared network. Moreover, the Tx UE may conduct a last minute evaluation as part of the LBT procedure prior to the initiating transmission within the resource selection window. And if the Tx UE determines that a reservation within the resource selection window has been made by another UE (e.g., a new high-priority reservation that was previously not detected during the selection process) that would be impacted if the transmitter UE continues with transmission, the Tx UE may modify or adjust the starting point of its transmission to align with the new high-priority reservation.

In other scenarios (e.g., while the Tx UE is within the reserved COT and performs re-evaluation during the COT to detect a new high-priority reservation by another UE), the Tx UE may modify its reservation by either (1) abandoning the COT T slots (e.g., 2 slots) before the high-priority reservation by another UE in order to allow the other UE to perform its LBT procedure and transmission of the packets during the preempted resources, or (2) initiate COT sharing with the high-priority UE if COT sharing is supported by both UEs. In the instance of COT sharing, the Tx UE may generate a gap within the resources for the high-priority UE to perform Type 2 LBT without interference, but both UEs may continue transmissions if the resources are non-overlapped (FDM).

In an example aspect includes a method of wireless communication by a user equipment, may comprise selecting a plurality of resources within a resource selection window for communication from a first user equipment (UE) to a second UE. The plurality of resources may be selected within the resource selection window to allow one or more other UEs with a higher-priority transmission than the first UE to gain access to the shared channel. And the plurality of resources selected by the first UE may have at least partially overlapping frequency resources reserved by the one or more other UEs. The method may further comprise performing, at the first UE, a listen-before-talk (LBT) procedure prior to initiating transmission from the first UE to the second UE. The method may further include transmitting, from the first UE to the second UE, one or more packets over the plurality of resources selected within the resource selection window based on a successful completion of the LBT procedure. Another example aspect includes an apparatus for wireless communication by a user equipment, comprising a memory and processor coupled with the memory. The method may include instructions executable by the processor to select a plurality of resources within a resource selection window for communication from a first user equipment (UE) to a second UE. The plurality of resources may be selected within the resource selection window to allow one or more other UEs with a higher-priority transmission than the first UE to gain access to the shared channel. And the plurality of resources selected by the first UE may have at least partially overlapping frequency resources reserved by the one or more other UEs. The instructions executable by the processor may further be configured to perform, at the first UE, a LBT procedure prior to initiating transmission from the first UE to the second UE. Additionally, instructions executable by the processor may further be configured to transmit, from the first UE to the second UE, one or more packets over the plurality of resources selected within the resource selection window based on a successful completion of the LBT procedure.

Another example includes an apparatus for wireless communication by a user equipment, comprising means for selecting a plurality of resources within a resource selection window for communication from a first user equipment (UE) to a second UE. The plurality of resources may be selected within the resource selection window to allow one or more other UEs with a higher-priority transmission than the first UE to gain access to the shared channel. And the plurality of resources selected by the first UE may have at least partially overlapping frequency resources reserved by the one or more other UEs. The apparatus may further include means for performing, at the first UE, a listen-before-talk (LBT) procedure prior to initiating transmission from the first UE to the second UE. The apparatus may further include means for transmitting, from the first UE to the second UE, one or more packets over the plurality of resources selected within the resource selection window based on a successful completion of the LBT procedure.

Another example includes a non-transitory computer readable medium storing instructions, executable by a processor, for wireless communications. The instructions, executable by the processor, include instructions for selecting a plurality of resources within a resource selection window for communication from a first user equipment (UE) to a second UE. The plurality of resources may be selected within the resource selection window to allow one or more other UEs with a higher-priority transmission than the first UE to gain access to the shared channel. And the plurality of resources selected by the first UE may have at least partially overlapping frequency resources reserved by the one or more other UEs. The instructions, executable by the processor, further include instructions for performing, at the first UE, a listen-before-talk (LBT) procedure prior to initiating transmission from the first UE to the second UE. The instructions, executable by the processor, further include instructions for transmitting, from the first UE to the second UE, one or more packets over the plurality of resources selected within the resource selection window based on a successful completion of the LBT procedure.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1A is a diagram illustrating an example of a wireless communications system and an access network.

FIG. 1B is a diagram illustrating an example of disaggregated base station architecture, in accordance with various aspects of the present disclosure.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3A is an example timing diagram for resource selection in accordance with various aspects of the present disclosure.

FIG. 3B is an example resource selection window that allows the UE to select multiple resources that exceed the number of transport blocks (TBs) that the UE may transfer in accordance with various aspects of the present disclosure.

FIG. 3C is an example timing diagram to allow UEs to initiate transmission prior to slot boundary in accordance with various aspects of the present disclosure.

FIG. 4A is an example of resource selection for an out-of-COT preemption in accordance with various aspects of the present disclosure.

FIG. 4B is an example of adjusting the transmission packet on a slot and sub-channel basis based in part on presence of other UEs reservations within the resource selection window in accordance with various aspects of the present disclosure.

FIG. 5A is one example of Tx UE accommodating the transmission by other UEs once transmission within the COT has initiated.

FIG. 5B is another example of Tx UE accommodating the transmission by other UEs once transmission within the COT has initiated.

FIG. 6 is a schematic diagram of an example implementation of various components of a user equipment in accordance with various aspects of the present disclosure.

FIG. 7 is a flow diagram of an example of a method of wireless communication implemented by the UE in accordance with aspects of the present disclosure.

### DETAILED DESCRIPTION

Some wireless communications systems may support sidelink communications between user equipments (UEs). Real-world applications of sidelink communications may include UE-to-network relaying, vehicle-to-vehicle (V2V) communications, vehicle-to-everything (V2X) communications, Internet of Everything (IoE) communications, Internet of Things (IoT) communications, mission-critical mesh, and/or various other suitable applications.

Two different categories of side-link communication are known based on the resource allocation method: mode-1 communication and mode-2 communication. Mode-1 communication is a method wherein a base station allocates usable resources for direct communication between terminals and can be used when all terminals that perform sidelink communication are in an in-coverage situation.

Mode-2 communication is a method wherein each terminal selects usable resources for direct communication. Mode-2 communication can be used even when the terminals are in an out-of-coverage situation. However, because the base station may not intervene in resource allocation, the UEs may need to identify usable resources itself, and the base station may implement a sensing process to determine which resources each terminal can use. For example, the base station may assign resource pools to the plurality of UEs, and each UE may autonomously perform the steps of resource selection. In some examples, a UE may perform a listen-before-talk (LBT) procedure to gain access to a sidelink bandwidth part (BWP) for a sidelink transmission. Sensing may be used for identifying resources that can be used for the sidelink, in order to decode the physical sidelink control channel (PSCCH) during a sensing window of a certain period before performing the sidelink transmission. Each UE may also perform resource reservation and signal the reservation of up to two additional resources for retransmissions via sidelink control information (SCI) message. Aspects of the present disclosure are directed to Mode-2 communication.

Particularly, in some examples, the sidelink communication is communicated using a licensed spectrum (e.g., unlike wireless local area networks, which typically use an unlicensed spectrum). One example of sidelink communication is PC5, for example, as used in V2V, long term evolution (LTE), and/or new radio (NR). In some cases, the UE may communicate using one or more frequency bands associated with a shared radio frequency spectrum, which may be referred to as unlicensed radio frequency spectrum bands. The shared spectrum may include radio frequency bands, which may not be reserved, allocated, or licensed for specific use cases or specific radio access technologies (RATs). In such systems, a UE may perform a listen-before-talk (LBT) procedure to gain access to a sidelink bandwidth part (BWP) for a sidelink transmission.

The deployment of sidelink over an unlicensed spectrum is referred to as sidelink unlicensed (SL-U). To avoid collisions in SL-U operations where all UEs contend for resources, the UEs may employ a LBT procedure to monitor for transmission opportunities. The LBT allows for the UEs to share the same channel. When LBT is enabled, a UE continuously monitors channels so as to transmit only when a channel is not in use or in resources not reserved by other UEs. When the LBT passes, the UE may proceed with the transmission. However, when the LBT fails, the UE may refrain from transmitting in the channel.

Typically, the SL-U operations after LBT failure may include resource reselection where the UE may again attempt to select a limited number of resources for retransmission. In such cases, the LBT failure may trigger a medium access layer (MAC) layer based resource reselection for the additional resources. However, since the MAC layer based resource reselection has a long delay, the additional resources may not be available when needed. In such circumstances, if a transmitter UE determines to use a resource, the resources may not be available at the requested time. And even if a resource is selected, there is uncertainty that the selected resources can be accessed in time, which can trigger another resource reselection and therefore degrade throughput due to additional latency.

Additionally, in some cases, the reserved resources may not be utilized. For example, if a first UE that originally selected and reserved certain resources on the shared channel, may elect not to transmit over the reserved resources at a particular time. In such instances, other UEs (e.g. one or more second UEs) that monitored the reservation by the first UE may unnecessarily exclude such resources during the resource selection procedure for the second UEs, which reduces the overall system capacity.

Indeed, due to the potential LBT uncertainty and resource scarcity, the UEs operating in SL-U may select longer resource allocation to increase the probability of completing LBT procedure. The UEs may also overbook the number of resources for transmission in order to prevent resources from being wasted by other UEs. Indeed, such a solution may include configuring the UE to select more resources than a number of transport blocks (TBs) for the initial transmission. Reservation of multiple resources, and particularly reservation of resources that are more than a number of TBs may allow the transmitter UE to have multiple LBT opportunities. The selected resources may be contiguous in time, and multiple TBs for the initial transmission can be transmitted in one COT. Thus, such a solution may result in a lower latency for the transmitter UE since the improved resource selection for the initial transmission in the SL-U operation minimizes transmission delay due to an LBT failure.

However, such a solution also comes with a number of drawbacks, including inter-UE blocking. An “inter-UE blocking” scenario may occur when the transmission of a first UE blocks the LBT of a second UE, even if the two transmission would not otherwise collide because the UEs would be transmitting during a different time period (TDM) or in different frequencies (FDM). Such scenario may occur in two instances.

First, in frequency duplex multiplexing (FDM), multiple UEs (e.g., first UE and second UE) with non-overlapping frequency allocation in the same LBT bandwidth part (e.g., first UE reserving a first sub-band of a slot and second UE reserving a second sub-band within the same time slot) may complete the respective LBTs at different times. For example, the first UE may complete the LBT first while the second UE may complete the LBT second. However, in such instance, the UE with later LBT completion (e.g., second UE) may not succeed in accessing the channel because the LBT for the second UE would fail due to the early transmission start by the first UE at the first sub-band of the time slot. Therefore, while the second UE would have utilized a second sub-band (i.e., nonoverlapping frequency allocation compared to the first UE reserving a first sub-band), the second UE would nonetheless be denied access to the channel due to early transmission start on the channel by the first UE.

Second, in time division multiplexing (TDM), if the multiple UEs select non overlapping time allocation (e.g., first UE selecting a first time slot and second UE selecting a second time slot). In such instance, the LBT of the second UE for the transmission in the second time slot would occur during the first time slot. But given the fact that the first UE would be transmitting during the first time slot, the second UE may be unable to clear the LBT for the second time slot. As such, the second UE may be deprived of an opportunity to transmit during a second time slot due to inter-UE blocking even if the resources in the second time slot remain available.

Thus, inter-UE blocking may adversely impact bandwidth utilization and prevent other UEs from accessing the channel. Such blocking may also adversely impact mission critical traffic for high priority UEs that may otherwise be prevented from accessing the shared channel.

Aspects of the present disclosure are directed to techniques to ensure that other UEs that may have reserved resources within the same resource selection window are allowed (or at least not prevented) from gaining access to the shared channel during their respective reserved resource period for both Out-of-COT and in-COT preemption window period.

Particularly, in some instances, the transmitter UE (e.g., Tx UE) may select a plurality of resources within a resource selection window for sidelink communication with the receiver UE (e.g., Rx UE) such that the access of any other UEs, particularly of a higher priority UE than the first UE, in the shared channels are not impacted. Thus, in some instances, if a resource candidate selection would risk blocking a high-priority transmission from another UE (within preemption window T) that has already made its resource reservations, the Tx UE may adjust the selection of the plurality of resources within the resource selection window to be aligned with the one of the other reserving UEs. As such, the Tx UE LBT procedure or transmission would not adversely impact the performance of other UEs on the shared network.

Moreover, the Tx UE may conduct a last minute evaluation as part of the LBT procedure prior to the initiating transmission within the resource selection window. And if the Tx UE determines that a reservation within the resource selection window has been made by another UE (e.g., a new high-priority reservation that was previously not detected during the selection process) that would be impacted if the transmitter UE continues with the transmission, the Tx UE may modify or adjust the starting point of its transmission to align with the new high-priority reservation.

In other scenarios (e.g., while the Tx UE is within the reserved COT and performs re-evaluation during the COT to detect a new high-priority reservation by another UE), the Tx UE may modify the reservation by either (1) abandoning the COT T slots (e.g., 2 slots) before the high-priority reservation by another UE in order to allow the other UE to perform its LBT procedure and transmission of the packets during the preempted resources, or (2) initiate COT sharing with the high-priority UE if COT sharing is supported by both UEs. In the instance of COT sharing, the Tx UE may generate a gap within the resources for the high-priority UE to perform Type 2 LBT without interference, but both UEs may continue transmissions if the resources are non-overlapped (FDM).

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

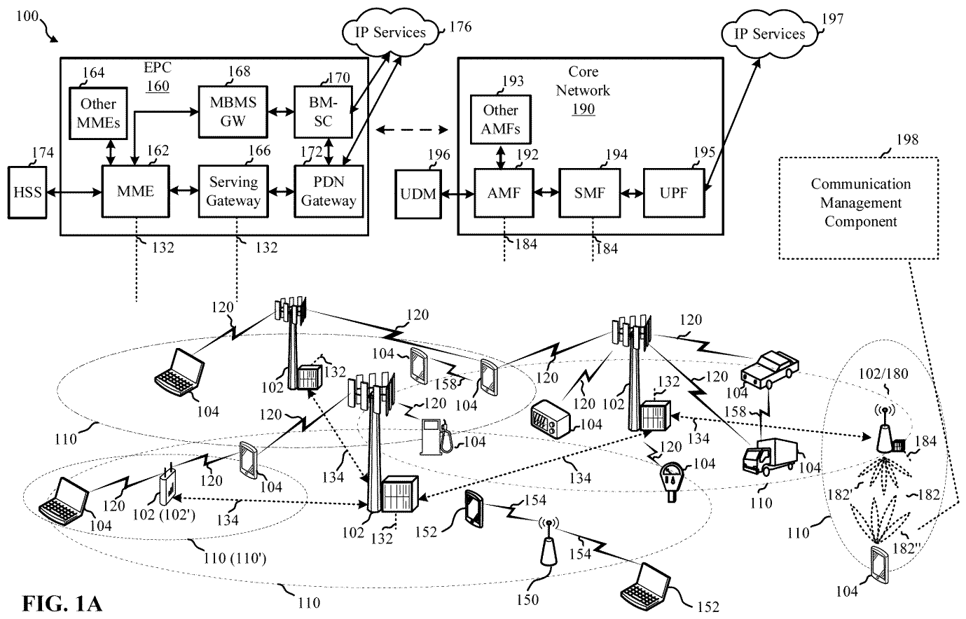

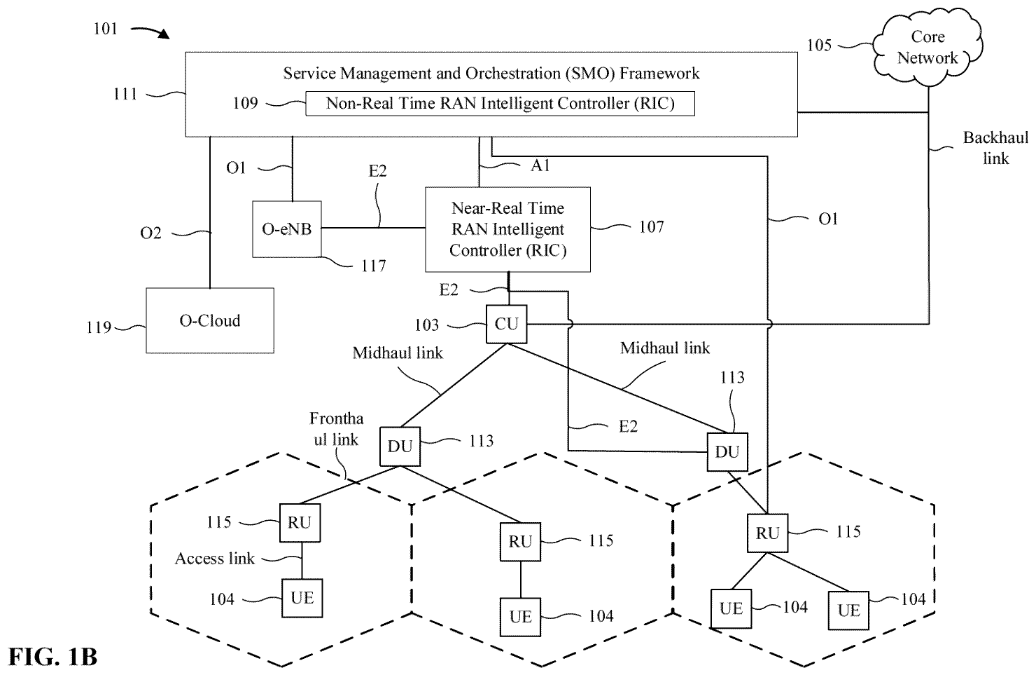

FIG. 1A is a diagram illustrating an example of a wireless communications system 100 (also referred to as a wireless wide area network (WWAN)) that includes base stations 102 (also referred to herein as network entities), user equipment(s) (UE) 104, an Evolved Packet Core (EPC) 160, and another core network 190 (e.g., a 5G Core (5GC)).

One or more of the UE 104 may include a communication management component 198, operable to perform techniques for selecting a plurality of resources within a resource selection window for communication from a first UE to a second UE, wherein the plurality of resources may be selected within the resource selection window to allow one or more additional UEs with a higher-priority transmission than the first UE and reserved resourced by the one or more UEs within a preemption window of the plurality of resources to gain access to the shared channel. The communication management component 198 may also perform, at the first UE, a LBT procedure prior to initiating transmission from the first UE to the second UE. The communication management component 198 may also transmit, from the first UE to the second UE, one or more packets over the plurality of resources selected within the resource selection window based on a successful completion of the LBT procedure. In some examples, the communication management component 198 may perform one or more functions for the UE as disclosed herein.

The base stations (or network entities) 102 may include macrocells (high power cellular base station) and/or small cells (low power cellular base station). The macrocells include base stations. The small cells include femtocells, picocells, and microcells. The base stations 102 can be configured in a Disaggregated RAN (D-RAN) or Open RAN (O-RAN) architecture, where functionality is split between multiple units such as a central unit (CU), one or more distributed units (DUs), or a radio unit (RU). Such architectures may be configured to utilize a protocol stack that is logically split between one or more units (such as one or more CUs and one or more DUs). In some aspects, the CUs may be implemented within an edge RAN node, and in some aspects, one or more DUs may be co-located with a CU, or may be geographically distributed throughout one or multiple RAN nodes. The DUs may be implemented to communicate with one or more RUs. Any of the disaggregated components in the D-RAN and/or O-RAN architectures may be referred to herein as a network entity.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G New Radio (NR) (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, Multimedia Broadcast Multicast Service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y megahertz (MHz) (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QoS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a Packet Switch (PS) Streaming Service, and/or other IP services.

The base station may include and/or be referred to as a network entity, gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, monitors, cameras, industrial/manufacturing devices, appliances, vehicles, robots, drones, etc.). IoT UEs may include machine type communications (MTC)/enhanced MTC (eMTC, also referred to as category (CAT)-M, Cat M1) UEs, NB-IoT (also referred to as CAT NB1) UEs, as well as other types of UEs. In the present disclosure, eMTC and NB-IoT may refer to future technologies that may evolve from or may be based on these technologies. For example, eMTC may include FeMTC (further eMTC), eFeMTC (enhanced further eMTC), mMTC (massive MTC), etc., and NB-IoT may include eNB-IoT (enhanced NB-IoT), FeNB-IoT (further enhanced NB-IoT), etc. The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the present disclosure may focus on 5G NR, the concepts and various aspects described herein may be applicable to other similar areas, such as LTE, LTE-Advanced (LTE-A), Code Division Multiple Access (CDMA), Global System for Mobile communications (GSM), or other wireless/radio access technologies.

FIG. 1B is a diagram illustrating an example of disaggregated base station 101 architecture, any component or element of which may be referred to herein as a network entity. The disaggregated base station 101 architecture may include one or more central units (CUs) 103 that can communicate directly with a core network 105 via a backhaul link, or indirectly with the core network 105 through one or more disaggregated base station units (such as a Near-Real Time (Near-RT) RAN Intelligent Controller (RIC) 107 via an E2 link, or a Non-Real Time (Non-RT) RIC 109 associated with a Service Management and Orchestration (SMO) Framework 111, or both). A CU 103 may communicate with one or more distributed units (DUs) 113 via respective midhaul links, such as an F1 interface. The DUs 113 may communicate with one or more radio units (RUs) 115 via respective fronthaul links. The RUs 115 may communicate with respective UEs 104 via one or more radio frequency (RF) access links. In some implementations, the UE 104 may be simultaneously served by multiple RUs 115.

Each of the units, e.g., the CUS 103, the DUs 113, the RUs 115, as well as the Near-RT RICs 107, the Non-RT RICs 109 and the SMO Framework 111, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 103 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 103. The CU 103 may be configured to handle user plane functionality (i.e., Central Unit-User Plane (CU-UP)), control plane functionality (i.e., Central Unit-Control Plane (CU-CP)), or a combination thereof. In some implementations, the CU 103 can be logically split into one or more CU-UP units and one or more CU-CP units. The CU-UP unit can communicate bidirectionally with the CU-CP unit via an interface, such as the E1 interface when implemented in an O-RAN configuration. The CU 103 can be implemented to communicate with the DU 113, as necessary, for network control and signaling.

The DU 113 may correspond to a logical unit that includes one or more base station functions to control the operation of one or more RUs 115. In some aspects, the DU 113 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the third Generation Partnership Project (3GPP). In some aspects, the DU 113 may further host one or more low PHY layers. Each layer (or module) can be implemented with an interface configured to communicate signals with other layers (and modules) hosted by the DU 113, or with the control functions hosted by the CU 103.

Lower-layer functionality can be implemented by one or more RUs 115. In some deployments, an RU 115, controlled by a DU 113, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 115 can be implemented to handle over the air (OTA) communication with one or more UEs 104. In some implementations, real-time and non-real-time aspects of control and user plane communication with the RU(s) 115 can be controlled by the corresponding DU 113. In some scenarios, this configuration can enable the DU(s) 113 and the CU 103 to be implemented in a cloud-based RAN architecture, such as a vRAN architecture.

The SMO Framework 111 may be configured to support RAN deployment and provisioning of non-virtualized and virtualized network elements. For non-virtualized network elements, the SMO Framework 111 may be configured to support the deployment of dedicated physical resources for RAN coverage requirements which may be managed via an operations and maintenance interface (such as an O1 interface). For virtualized network elements, the SMO Framework 111 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 103, DUs 113, RUs 115 and Near-RT RICs 107. In some implementations, the SMO Framework 111 can communicate with a hardware aspect of a 4G RAN, such as an open eNB (O-eNB) 117, via an O1 interface. Additionally, in some implementations, the SMO Framework 111 can communicate directly with one or more RUs 115 via an O1 interface. The SMO Framework 111 also may include a Non-RT RIC 109 configured to support functionality of the SMO Framework 111.

The Non-RT RIC 109 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 107. The Non-RT RIC 109 may be coupled to or communicate with (such as via an A1 interface) the Near-RT RIC 107. The Near-RT RIC 107 may be configured to include a logical function that enables near-real-time control and optimization of RAN elements and resources via data collection and actions over an interface (such as via an E2 interface) connecting one or more CUs 103, one or more DUs 113, or both, as well as an O-eNB, with the Near-RT RIC 107.

In some implementations, to generate AI/ML models to be deployed in the Near-RT RIC 107, the Non-RT RIC 109 may receive parameters or external enrichment information from external servers. Such information may be utilized by the Near-RT RIC 107 and may be received at the SMO Framework 111 or the Non-RT RIC 109 from non-network data sources or from network functions. In some examples, the Non-RT RIC 109 or the Near-RT RIC 107 may be configured to tune RAN behavior or performance. For example, the Non-RT RIC 109 may monitor long-term trends and patterns for performance and employ AI/ML models to perform corrective actions through the SMO Framework 111 (such as reconfiguration via O1) or via creation of RAN management policies (such as A1 policies).

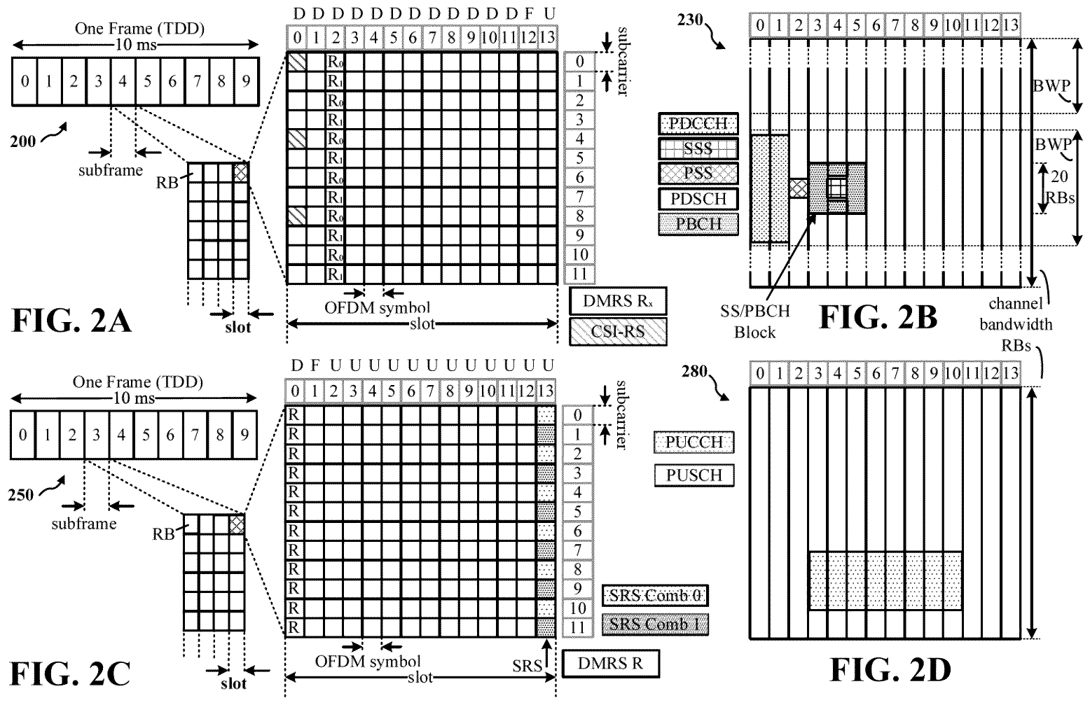

FIGS. 2A-2D are diagrams of various frame structures, resources, and channels used by UEs 104 and base stations 102/180 for communication. FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency-division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 24 slots/subframe. The subcarrier spacing and symbol length/duration are a function of the numerology. The subcarrier spacing may be equal to 2^{μ}*15 kilohertz (kHz), where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rx for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data, and may additionally be used to carry a buffer status report (BSR), a power headroom report (PHR), and/or UCI.

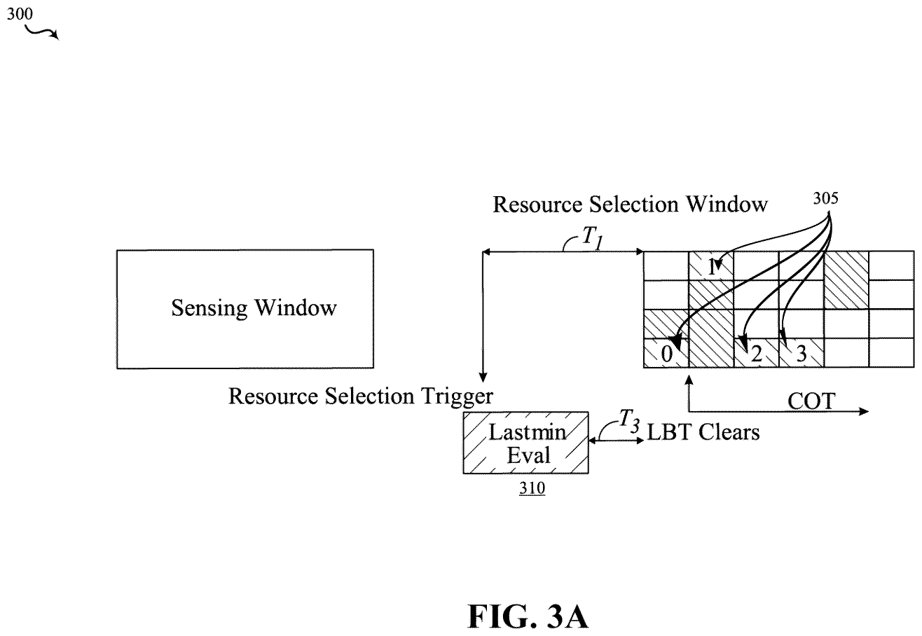

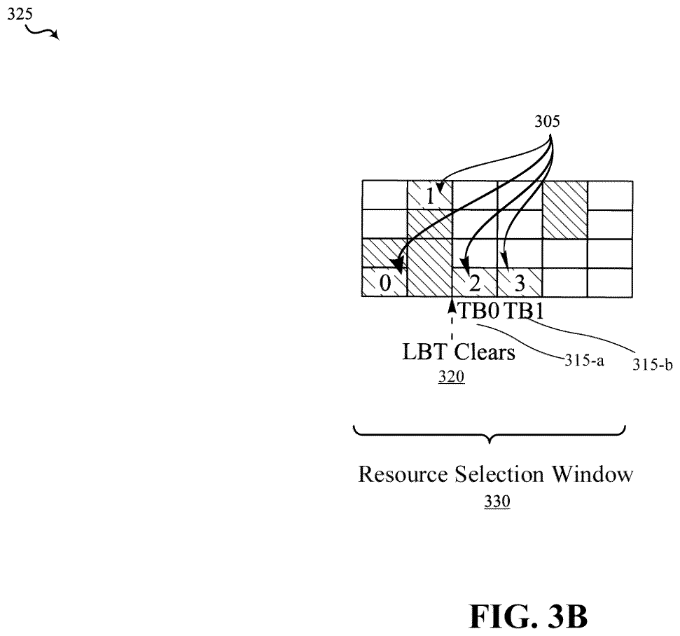

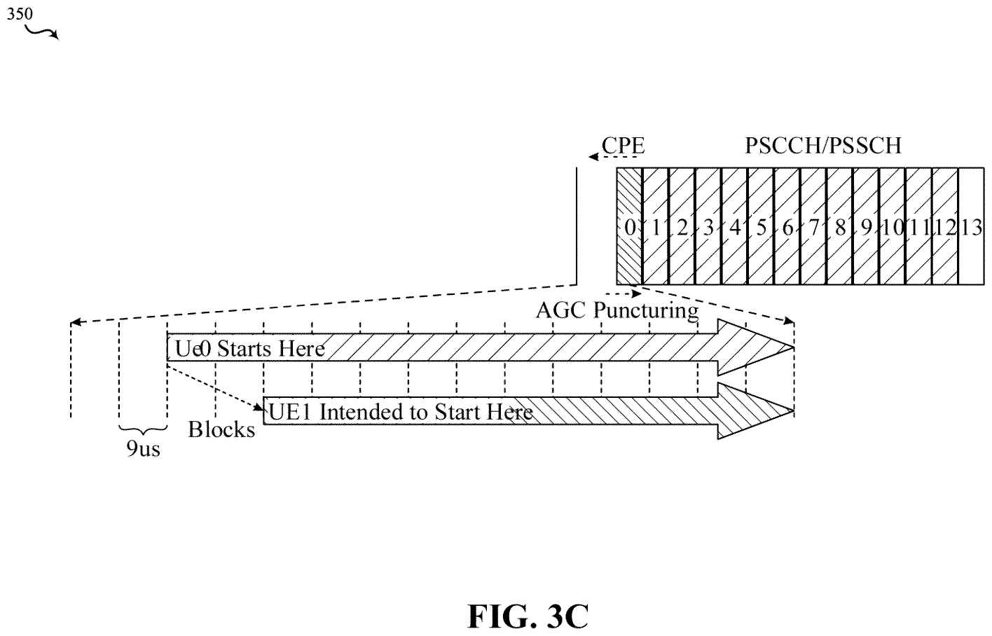

FIG. 3A illustrates a timing diagram 300 for resource selection used for SL-U communications. As noted above, in SL-U operations, resource selection methods allow UEs to select a limited number of resources 305 (e.g., for initial and later transmissions). However, if the UE LBT operation 310 fails, UE may seek additional resources (e.g., to again clear LBT procedures and retransmission). In such cases, the LBT failure may trigger a media access control (MAC) layer based resource reselection for the additional resources. But since the MAC layer based resource reselection has long delays, the additional resources may not be available when needed.

In some examples, in order to remedy the issues with the LBT uncertainty, techniques may be implemented that allow UEs to reserve more resources than the number of TBs that the UE intends to transfer during the initial transmission. By reserving more resources than the number of TBs the UE intends to transfer, the UE 104 may ensure multiple LBT opportunities. Thus, as illustrated in FIG. 3A, the first number of resources 305 may be selected in different slots or resource blocks (RBs), and the transmitter UE 104 may perform an LBT procedure on the one or more of the first number of resources as part of the last minute evaluation 310 performed prior to initiating transmission.

Such techniques may result in a lower latency, since the resource selection for the initial transmission in the SL-U operation reduces and/or minimizes transmission delay due to a single LBT failure. And the utilization of CPE may allow one or more UEs to initiate transmission prior to the resource boundary in order to silence other UEs (since the one or more second UEs may fail their LBT given that the transmitter UE has already started transmission before the boundary reservation).

FIG. 3B is an example resource selection window 330 that allows the UE to select multiple resources 305 that exceed the number of TBs (e.g., first TB 315-a and second TB 315-b) that UE may transfer on the SL-U to a second UE. Particularly, in some examples, the MAC layer of the transmitter UE, during a resource selection window 305, may overbook resources in time to provide physical (PHY) layer of the transmitter UE more opportunities to clear the LBT. In some cases, when an interference in the different slots or the different RB-set is un-correlated, the PHY layer may have a higher chance to clear the LBT in one of the other reserved opportunities. The selected resources (e.g., slots) may be contiguous or non-contiguous in time. The transmitter UE may also use an earliest opportunity based on time ordering to clear the LBT.

In certain aspects, the transmitter UE 104 performs an LBT procedure across multiple LBT sub-bands. For example, when multiple frequency domain opportunities are available in a same slot associated with the first number of resources, the transmitter UE may perform the LBT across multiple LBT sub-bands that may be selected based on MAC indicated preferred ordering.

Thus, in some cases, when the transmitter UE 104 has two TBs (e.g., TB0 315-a and TB1 315-b) to transmit, the UE may still select four contiguous resources 305 in time. In such case, the transmitter UE 104 may utilize the first set of resources (e.g., resource “0” and “1”) for the LBT procedure 320 that may conclude prior to the third resource 305 (resource “2”). Thus, the UE may transmit TB0 315-a and TB1 315-b within one COT in selected resources “2” and “3”.

Additionally, in some cases as illustrated in FIG. 3C, the selected resources may be contiguous in time, and multiple TBs for the initial transmission may be transmitted in one COT. The UE may also indicate a cyclic prefix extension (CPE) duration for the selected resources during an initial transmission. The technique may allow the UE to modify the CPE such that the UE may start the transmission on the SL-U channel before the reserved block in lieu of performing an entire resource reselection. Particularly, in some instances of SL-U operation, multiple UEs 104 may contend for a channel access at the same time. In such cases, when intended transmissions by multiple UEs start at the same time, there may be traffic collisions. For example, the multiple UEs may identify an empty channel before a slot boundary and then start their respective transmission at the same time at the slot boundary. Accordingly, the multiple UEs may interfere with each other.

Thus, multiple contention slots (e.g., of 9 us each) may be provided before a slot boundary with a CPE. Each UE may hash to one of a plurality of starting points. In such cases, the UE hashed to an earlier starting point may be allowed to start transmission earlier in order to stop another UE hashed to later starting point. Thus, it may be advantageous for the UE to select an earlier starting point from a set of starting points for its transmission. But in order to prevent all UEs contending for an earlier starting point, the UEs may select the starting point based on one or more rules that ensure fair access to all the UEs. For examples, the selection of the starting point may be based on the priority of transmissions. The multiple rules may also include randomizing a starting point from a set of starting points (e.g., the starting point may not need be fixed, and some randomness in selection of the starting point by the UE may improve fairness for a plurality of UEs). In other examples, the different sets of starting points may be associated with different channel access priority class (CAPC) values. In yet another example, the UE may be configured to access an earlier starting point after the UE has failed LBT procedure multiple times. For example, the UE may be allowed to be more aggressive to access an earlier starting point, if the UE keeps failing the LBT procedure.

However, the “overbooking” of resources and utilization of CPE to gain earlier access to SL-U channel provides a number of drawbacks, including inter-UE blocking. Specifically, in an “inter-UE blocking” scenario, the resource selection and transmission of a first UE may block the LBT of a second UE, even if the two transmission would not otherwise collide. Overbooking the resources or using CPE also does not prevent inter-UE blocking of higher priority UEs since each UE aggressively overbooks multiple resources and prevents access to other UEs to the channel due to self-interest of ensuring that its own packets are transferred over the channel. Such operations and techniques may have negative overall impact, including to for services associated with eMBB or mission critical traffic.

Aspects of the present disclosure are directed to techniques to ensure that other UEs that may have reserved resources within the same resource selection window are allowed (or at least not prevented) from gaining access to the shared channel during their respective reserved resource period for both Out-of-COT and in-COT preemption window period.

Particularly, in some instances, the transmitter UE (e.g., Tx UE) may select a plurality of resources within a resource selection window for sidelink communication with the receiver UE (e.g., Rx UE) such that the access of any other UEs, particularly of a higher priority UE than the first UE, in the shared channels are not impacted. Thus, in some instances, if a resource candidate selection would risk blocking a high-priority transmission from another UE (within preemption window T) that has already made its resource reservations, the Tx UE may adjust the selection of the plurality of resources within the resource selection window to be aligned with the one of the other reserving UEs. As such, the Tx UE LBT procedure or transmission would not adversely impact the performance of other UEs on the shared network.

Moreover, the Tx UE may conduct a last minute evaluation as part of the LBT procedure prior to the initiating transmission within the resource selection window. And if the Tx UE determines that a reservation within the resource selection window has been made by another UE (e.g., a new high-priority reservation that was previously not detected during the selection process) that would be impacted if the transmitter UE continues with the transmission, the Tx UE may modify or adjust the starting point of its transmission to align with the new high-priority reservation.

In other scenarios (e.g., while the Tx UE is within the reserved COT and performs re-evaluation during the COT to detect a new high-priority reservation by another UE), the Tx UE may modify its reservation by either (1) abandoning the COT T slots (e.g., 2 slots) before the high-priority reservation by another UE in order to allow the other UE to perform its LBT procedure and transmission of the packets during the preempted resources, or (2) initiate COT sharing with the high-priority UE if COT sharing is supported by both UEs. In the instance of COT sharing, the Tx UE may generate a gap within the resources for the high-priority UE to perform Type 2 LBT without interference, but both UEs may continue transmissions if the resources are non-overlapped (FDM).

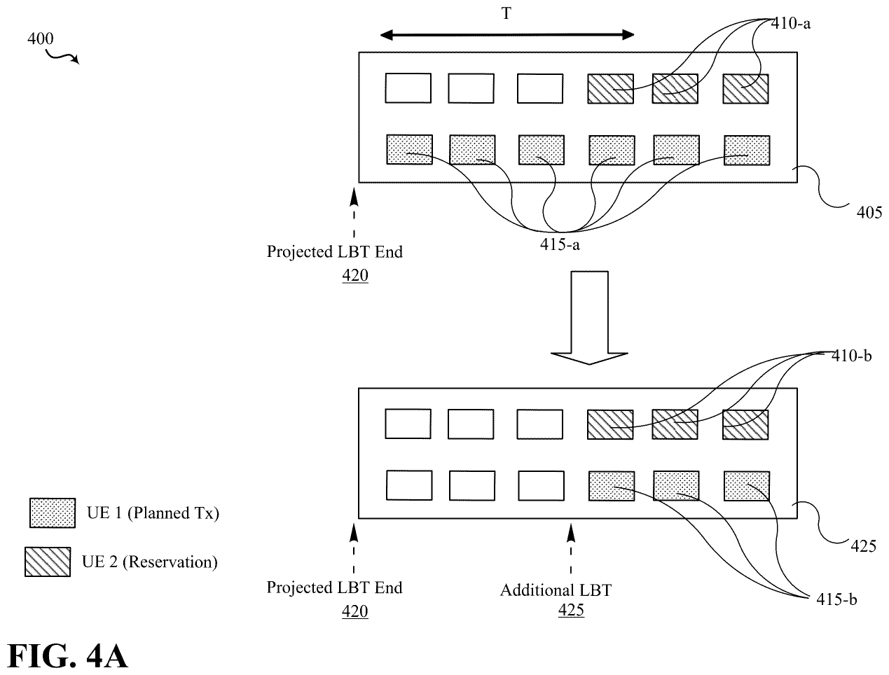

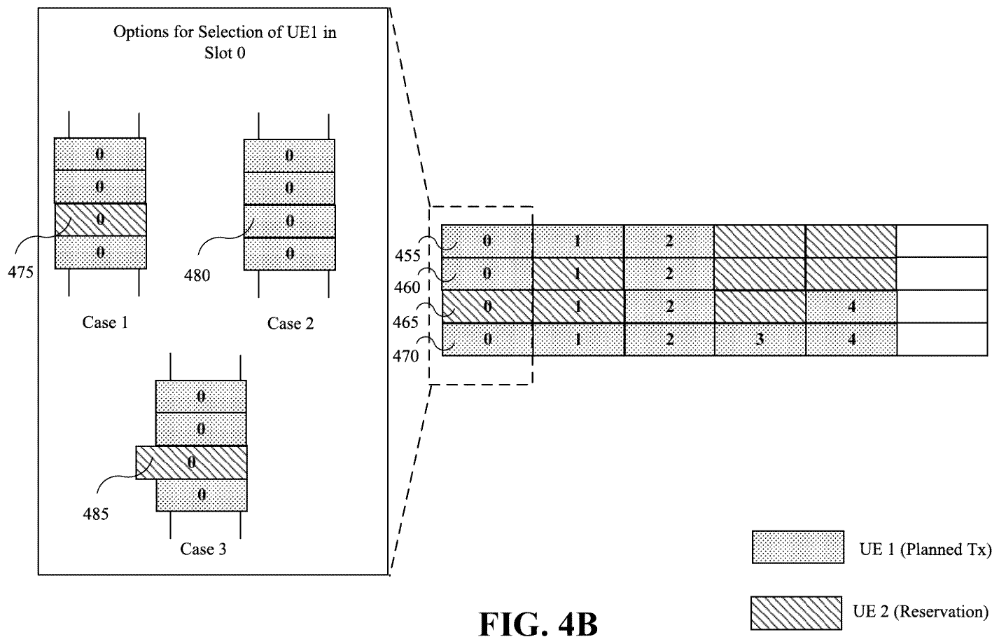

FIG. 4A is a resource selection diagram 400 for an out-of-COT preemption window. In some examples, the PHY layer of a Tx UE 104 may examine a sensing window to identify candidate resources in a resource selection window (e.g., 405, 425). After identifying the set of candidate resources, the PHY layer may report the set of candidate resources to a MAC layer of the UE 104. The MAC layer may then select, during a first time period (e.g., during the selection period), one or more resources from the set of candidate resources within the resource selection window reported by the PHY layer for a transmission during a second time period.

In some examples, the Tx UE MAC (e.g., for UE 1) can select resources 415-a within the selection window according to a parameter T (preemption window). However, if a candidate selection of resources 415-a would block the transmission of another UE (e.g., UE 2) that may be a high-priority UE or include high priority traffic that has already reserved resources 410-a within the preemption window (T) (as shown in resource selection window 405), the Tx UE 104 (UE 1) may modify its resource selection such that the reserved resources 415-b are aligned with the high-priority UE (e.g., UE 1) reserved resources 410-b (as shown in resource selection window 410). For example, the UE 1 may perform a long resource selection at t1 (first time period) to start transmission at t2 (second time period). Another UE (e.g., UE 2) may also perform resource reservations at t2 to start its transmissions at t2′. In such instance, the Tx UE (UE 1) may perform a last minute evaluation at a certain time period (e.g., t3) prior to the start of the transmission corresponding to UE 1 (e.g., t1′). In such scenario, the selection for resource reservations from UE 2 may occur either: (1) before UE 1 makes it resource selection (e.g., t2<t1) or (2) after UE1 has already made its resource selection, but before UE1 starts the transmission on the reserved resources (e.g., t1<t2<t3).

Thus, in the first scenario (e.g., where the selection for resource reservations 410-a from UE 2 occur before UE 1 makes it own resource selection 415-a (e.g., t2<t1)), the Tx UE 104 (e.g., UE 1) may determine that the projected resource reservations 415-a for UE 1 may impact or be close to the LBT end period for the UE 2. In other words, the Tx UE 104 (e.g., UE 1) may determine that the projected transmissions in resources 415-a may prevent one or more second UEs (e.g., UE 2) from initiating the transmission in the reserved resources 410-a. As such, in order to not impede or prevent other UEs from accessing the shared channel at their reserved resources, Tx UE 104 (e.g., UE 1) may modify the starting resource to align with UE 2 as shown in resource selection window 425. The alignment may include selecting the starting point for transmission of communications for Tx UE 104 (e.g., UE 1) from originally scheduled t1' to t2′, with both UEs selecting different frequency resources within the same time period (e.g., FDM). In other words, the starting points for transmissions for both UE 1 and UE 2 would be aligned and the frequency resources would be diversified such that both UEs 104 may independently initiate transmissions over the shared channel without impacting the ability of the other UE's 104 access to the shared channel.

In the second scenario (e.g., the selection for resource reservations from UE 2 may occur after UE1 has already made its resource selection, but before UE1 starts the transmission on the reserved resources (e.g., t1<t2<t3)), the UE 1 may perform a last minute evaluation at t3 and determine the presence of resource reservations 410-a from UE 2. In such instance, Tx UE 104 (UE 1) may defer, based in part on priority of UEs, the starting time of the transmission of UE 1 from t1′ to t2′. Thus, even if the Tx UE 104 (e.g., UE 1), when originally selecting a plurality of resources 415-a fails to identify that any other UE has made resource reservations within the resource selection window at the time of Tx UE 104 resource selection, the techniques provided herein also account for any later reservation of resources that may be made by another UE. For example, prior to initiating any transmission over the shared channel, the Tx UE 104 may conduct a last minute evaluation (e.g., LBT 420). In such instance, if a new high-priority reservation 410-a is detected during the LBT 420 (e.g., that was previously not detected or not reserved), the Tx UE 104 may also again modify the starting point of Tx UE 104 transmissions that is aligned with the reservation as shown in resource selection window 425. Such procedure may be treated as in Type 1 LBT when the device is not ready for transmission and will do an additional LBT for 25 us before transmission starts.

Thus, features of the present disclosure resolve scenarios where, for example, other UEs (e.g., one or more UE 2s) have reserved resources 410-a at the time that Tx UE 104 (e.g., UE 1) selects the resources for its own transmission or if the reservations by the other UEs arrive after the Tx UE 104 has completed the reservation, but prior to initiating transmission.

FIG. 4B is an example of resource selection window 450 that illustrates the Tx UE 104 adjusting the transmission packet on a slot and sub-channel basis based in part on presence of other UEs reservations within the resource selection window. As noted above, in some examples, the Tx UE 104 may seek to transmit multiple TBs to the Rx UE 104. As such, the Tx UE 104 may select a plurality of resources within the resource selection window before starting LBT. The Tx UE 104 making the “long” resource selection may be ready to begin transmission on the reserved resources as soon as the Tx UE 104 clears the LBT. After clearing the LBT, the Tx UE 104 may transmit multiple TBs over the reserved resources.

Thus, as discussed above, the Tx UE 104 may select a different set of resources per slot based on any existing reservations by one or more other UEs (e.g., UE 2). The Tx UE 104 may also generate multiple versions of a packet (or multiple packets) to be transmitted such that the Tx UE 104, following the LBT, may adjust the packet to be transmitted to align with available resources.

Particularly, the MAC layer of the Tx UE 104 may request a set of available resources from the PHY and determine which resources within the resource selection window are blocked by other UEs. The report from PHY to MAC may provide the outcome in terms of each slot and subchannel, the outcome of the reference signal received power (RSRP) thresholding and the priority level of the other UEs that have reserved the resources within the resource selection window. And based on the priority level of the other UEs (e.g., UE 2) that have reserved the resources, the Tx UE (e.g., UE 1) may adjust the particular slot, subchannel or CPE for transmission of its own traffic.

For instance, in slot 0, the Tx UE 104 (e.g., UE 1) may reserve the first subchannel 455, second subchannel 460, and the fourth subchannel 470. In the same slot 0, another UE (e.g., UE 2) may reserve a third subchannel 465. A high capability Tx UE 104 may prepare multiple version of the first packet (e.g., same TB) to avoid existing reservations, and elect the version of packet to transmit after LBT completion based on the priority of the Tx UE (e.g., UE 1) in comparison to the other UE (e.g., UE 2) that has also reserved in the same slot.

Thus, in the illustrated example, if the priority of either UE is indeterminate or inconsequential (Case 1), both UE 1 and UE 2 may transmit in their respective reserved subchannels at the predetermined CPE (e.g., transmission start time). If, however, the UE 1 has a higher priority than UE 2, the UE 1 may transmit not only in its previously reserved first subchannel 455, second subchannel 460, and the fourth subchannel 470, but may initiate a longer CPE over each of first subchannel 455, second subchannel 460, third subchannel 465 and the fourth subchannel 470 in order to start transmitting on all subchannels in slot 0 prior to UE 2. By starting the transmission earlier than the slot 0 boundary, the UE 1 may be able to silence UE 2 from transmitting over the third subchannel 465. Conversely, if UE 2 has higher priority than UE 1, the UE 1 may wait to start transmitting on the reserved first subchannel 455, second subchannel 460, and the fourth subchannel 470 until the slot 0 boundary. As such, the UE 2 that has higher priority than UE 1 would not be prevented from transmitting over its reserved third subchannel 465. Indeed, UE 2 may also initiate its transmission on the third subchannel 465 earlier than UE 1 for slot 0 by adjusting the CPE. As such, the Tx UE 104 (e.g., UE 1) may ensure that overbooking resources within resource selection window does not adversely impact other UEs, particularly those with higher priority traffic.

Additionally or alternatively, once the Tx UE 104 has initiated transmission within a COT, the UE may also respect the preemption of other UEs (e.g., UE 2) and either abandon the COT corresponding to Tx UE 104 or initiate COT sharing with the other UEs in order to facilitate equitable sharing of resources on the shared channel.

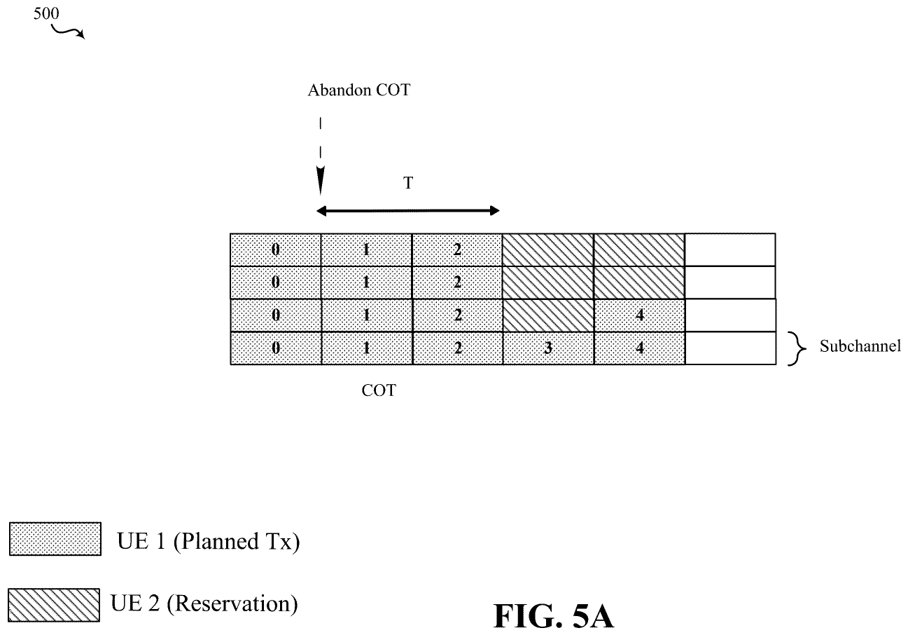

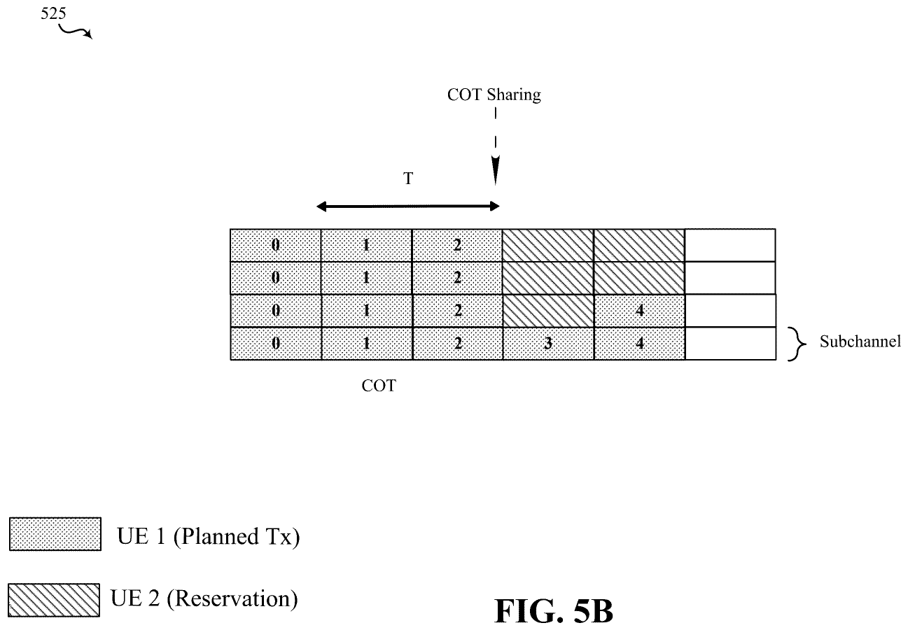

FIG. 5A is one example of Tx UE 104 accommodating the transmission by other UEs once transmission within the COT has initiated. In some aspects, once a Tx UE 104 detects (potentially prior to start of COT) some reservations within the COT resources, one or more resource reservations by other UEs, the Tx UE 104 may accommodate the resource preemptions by the other UEs based in part on priority of the reservations. Thus, in one example, as illustrated in FIG. 5A, the Tx UE 104 may abandon the COT at least T slots (e.g., two slots where T is the preemption window) prior to the start of the reservation for the other UEs (e.g., UE 2).

In other examples, as illustrated in FIG. 5B, the Tx UE 104 may also share the COT with other UEs if the UEs support COT sharing. In such instance, the Tx UE 104 may signal COT sharing to the UE 2 so that the reserving UE (e.g., UE 2) may access the resources via Type 2 LBT. The Tx UE 104 may create a gap for the Type 2 LBT for the UE 2, but continue transmissions if the resources are non-overlapping (e.g., FDM) which may require a short LBT to resume transmission. Additionally or alternatively, the COT sharing may be allowed if the Tx UE 104 has data for initiator. In one instance, a field may be added in reservation SCI-1 to declare beforehand the receiver UE that the data is designated for. In other examples, the COT initiator can invite another UE for COT sharing, and the responder can share if the initiator is a destination ID for the TB.

In some examples, the preemption window value (T) may be determined separately for each UE, may be based on a function of the priority values in UE SCIs (e.g., the UE can maintain a list of neighbor UEs with statistics of the priorities over time), time window to compute the function, or the preemption window value may be determined on a per reservation basis (e.g., based on the priority of the specific reservation).

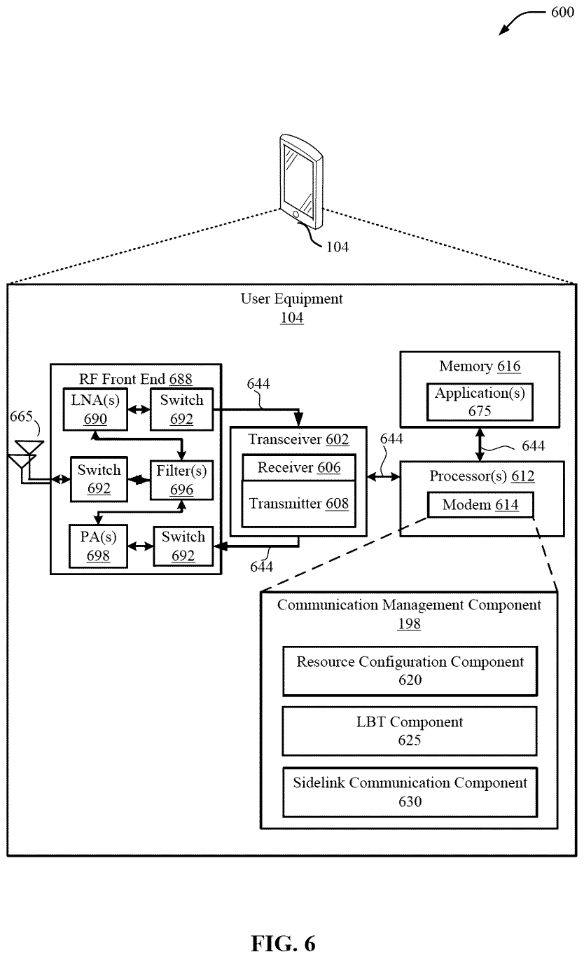

FIG. 6 illustrates a hardware components and subcomponents of a device that may be a UE 104 for implementing one or more methods (e.g., method 700) described herein in accordance with various aspects of the present disclosure. The UE 104 may be an example of UE 104 disclosed with reference to FIG. 1A. For example, one example of an implementation of the UE 104 may include a variety of components, some of which have already been described above, but including components such as one or more processors 612, memory 616 and transceiver 602 in communication via one or more buses 644, which may operate in conjunction with the communication management component 198 to perform functions described herein related to including one or more methods (e.g., 700) of the present disclosure.

Particularly, the communication management component 198 may include a resource configuration component 620 for selecting a plurality of resources within a resource selection window for communication from a first UE to a second UE. The plurality of resources may be selected within the resource selection window to allow one or more additional UEs with a higher-priority transmission than the first UE and reserved resourced by the one or more UEs within a preemption window of the plurality of resources to gain access to the shared channel. The communication management component 198 may also include an LBT component 625 to perform, at the first UE, a LBT procedure prior to initiating transmission from the first UE to the second UE. The communication management component 198 may also include a sidelink communication component 630 to transmit, from the first UE to the second UE, one or more packets over the plurality of resources selected within the resource selection window based on a successful completion of the LBT procedure.

The one or more processors 612, modem 614, memory 616, transceiver 602, RF front end 688 and one or more antennas 665, may be configured to support voice and/or data calls (simultaneously or non-simultaneously) in one or more radio access technologies. In an aspect, the one or more processors 612 can include a modem 514 that uses one or more modem processors. The various functions related to communication management component 198 may be included in modem 614 and/or processors 612 and, in an aspect, can be executed by a single processor, while in other aspects, different ones of the functions may be executed by a combination of two or more different processors. For example, in an aspect, the one or more processors 612 may include any one or any combination of a modem processor, or a baseband processor, or a digital signal processor, or a transmit processor, or a receiver processor, or a transceiver processor associated with transceiver 602. In other aspects, some of the features of the one or more processors 612 and/or modem 614 associated with communication management component 198 may be performed by transceiver 602.

The memory 616 may be configured to store data used herein and/or local versions of application(s) 675 or communication management component 198 and/or one or more of its subcomponents being executed by at least one processor 612. The memory 616 can include any type of computer-readable medium usable by a computer or at least one processor 612, such as random access memory (RAM), read only memory (ROM), tapes, magnetic discs, optical discs, volatile memory, non-volatile memory, and any combination thereof. In an aspect, for example, the memory 616 may be a non-transitory computer-readable storage medium that stores one or more computer-executable codes defining communication management component 198 and/or one or more of its subcomponents, and/or data associated therewith, when the UE 104 is operating at least one processor 612 to execute communication management component 198 and/or one or more of its subcomponents.

The transceiver 602 may include at least one receiver 606 and at least one transmitter 608. The receiver 606 may include hardware, firmware, and/or software code executable by a processor for receiving data, the code comprising instructions and being stored in a memory (e.g., computer-readable medium). The receiver 606 may be, for example, a radio frequency (RF) receiver. In an aspect, the receiver 606 may receive signals transmitted by at least one UE 104. Additionally, receiver 606 may process such received signals, and also may obtain measurements of the signals, such as, but not limited to, Ec/Io, SNR, RSRP, RSSI, etc. The transmitter 608 may include hardware, firmware, and/or software code executable by a processor for transmitting data, the code comprising instructions and being stored in a memory (e.g., computer-readable medium). A suitable example of the transmitter 608 may including, but is not limited to, an RF transmitter.

Moreover, in an aspect, transmitting device may include the RF front end 688, which may operate in communication with one or more antennas 665 and transceiver 602 for receiving and transmitting radio transmissions, for example, wireless communications transmitted by at least one base station 102 or wireless transmissions transmitted by UE 104. The RF front end 688 may be connected to one or more antennas 665 and can include one or more low-noise amplifiers (LNAs) 690, one or more switches 692, one or more power amplifiers (PAS) 698, and one or more filters 696 for transmitting and receiving RF signals.

In an aspect, the LNA 690 can amplify a received signal at a desired output level. In an aspect, each LNA 690 may have a specified minimum and maximum gain values. In an aspect, the RF front end 688 may use one or more switches 692 to select a particular LNA 690 and its specified gain value based on a desired gain value for a particular application.

Further, for example, one or more PA(s) 698 may be used by the RF front end 688 to amplify a signal for an RF output at a desired output power level. In an aspect, each PA 698 may have specified minimum and maximum gain values. In an aspect, the RF front end 688 may use one or more switches 692 to select a particular PA 698 and its specified gain value based on a desired gain value for a particular application.

Also, for example, one or more filters 696 can be used by the RF front end 658 to filter a received signal to obtain an input RF signal. Similarly, in an aspect, for example, a respective filter 696 can be used to filter an output from a respective PA 698 to produce an output signal for transmission. In an aspect, each filter 696 can be connected to a specific LNA 690 and/or PA 698. In an aspect, the RF front end 688 can use one or more switches 592 to select a transmit or receive path using a specified filter 696, LNA 690, and/or PA 698, based on a configuration as specified by the transceiver 602 and/or processor 612.

As such, the transceiver 602 may be configured to transmit and receive wireless signals through one or more antennas 665 via the RF front end 688. In an aspect, the transceiver 602 may be tuned to operate at specified frequencies such that transmitting device can communicate with, for example, one or more base stations 102 or one or more cells associated with one or more base stations 102 or other UEs 104. In an aspect, for example, the modem 614 can configure the transceiver 602 to operate at a specified frequency and power level based on the configuration of the transmitting device and the communication protocol used by the modem 614.

In an aspect, the modem 614 can be a multiband-multimode modem, which can process digital data and communicate with the transceiver 602 such that the digital data is sent and received using the transceiver 602. In an aspect, the modem 614 can be multiband and be configured to support multiple frequency bands for a specific communications protocol. In an aspect, the modem 614 can be multimode and be configured to support multiple operating networks and communications protocols. In an aspect, the modem 614 can control one or more components of transmitting device (e.g., RF front end 688, transceiver 602) to enable transmission and/or reception of signals from the network based on a specified modem configuration. In an aspect, the modem configuration can be based on the mode of the modem 614 and the frequency band in use. In another aspect, the modem configuration can be based on UE configuration information associated with transmitting device as provided by the network during cell selection and/or cell reselection.

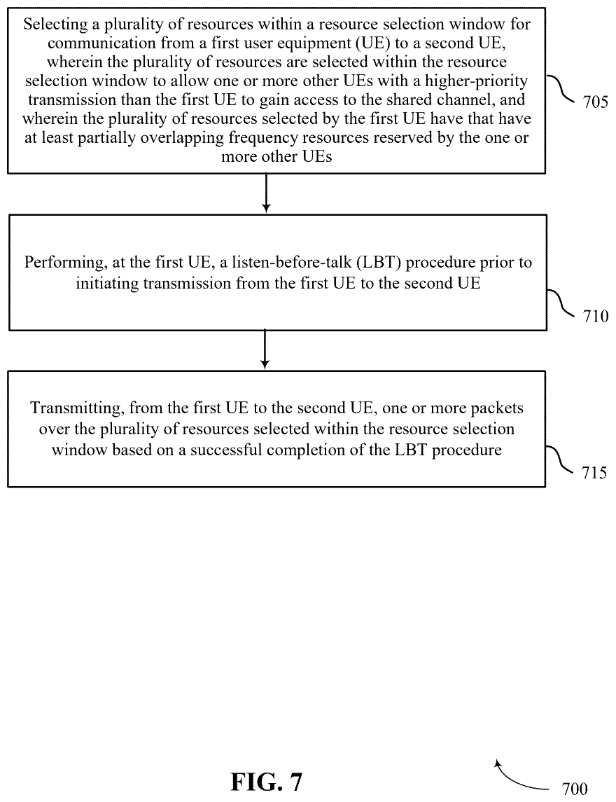

Referring to FIG. 7, an example method 700 for wireless communications in accordance with aspects of the present disclosure may be performed by one or more UEs 104 discussed with reference to FIGS. 1A. Although the method 700 is described below with respect to the elements of the UE 104, other components may be used to implement one or more of the steps described herein.

At block 705, the method 700 may include selecting a plurality of resources within a resource selection window for communication from a first user equipment (UE) to a second UE. The plurality of resources may be selected within the resource selection window to allow one or more other UEs with a higher-priority transmission than the first UE to gain access to the shared channel. And the plurality of resources selected by the first UE may have at least partially overlapping frequency resources reserved by the one or more other UEs. In some examples, the method of block 705 may be performed by the processor 612, the modem 644, the communication management component 198, the resource configuration component 620 in and/or one or more other components or subcomponents of the UE 104.

In some examples, the plurality of resources within the resource selection window may be selected such that a first starting time for transmission by the first UE to the second UE and a second starting time for the higher-priority transmission by the one or more additional UEs in the shared channel may be no earlier than a slot. In other examples, the plurality of resources within the resource selection window may be selected such that a first starting time for transmission by the first UE to the second UE and a second starting time for the higher-priority transmission by the one or more additional UEs in the shared channel is aligned within a slot. In other words, the starting time based on the CPE may be aligned for the UEs initiating transmission within each slot.

In some examples, selecting the plurality of resources within the resource selection window for communication from the first UE to the second UE comprises receiving, at the first UE, a first set of available resources for one or more slots and subchannels within the resource selection window. The method may also include selecting the plurality of resources within the resource selection window from the first set of available resources based on identification of resources that are blocked by the one or more other UEs with the higher-priority transmission.

In some examples, selecting the plurality of resources within the resource selection window for communication from the first UE to the second UE includes selecting a sub-slot transmission starting point for the plurality of resources selected by the first UE. In some examples, the sub-slot transmission starting point may indicate the CPE duration time. In some aspects, the at least partially overlapping frequency resources reserved by the one or more other UEs may indicate its respective sub-slot transmissions stating point as well.

In some examples, the partially overlapping frequency resources includes overlapping LBT bandwidth needed by the one or more other UEs to complete the LBT procedure. Additionally or alternatively, the partially overlapping frequency resources may include overlapping subchannels as the plurality of resources selected by the first UE.

In certain implementations, the processor 612, the modem 644, the communication management component 198, the resource configuration component 620 in and/or one or more other components or subcomponents of the UE 104 may be configured to and/or may define means for selecting a plurality of resources within a resource selection window for communication from a first user equipment (UE) to a second UE. The plurality of resources may be selected within the resource selection window to allow one or more other UEs with a higher-priority transmission than the first UE to gain access to the shared channel. And the plurality of resources selected by the first UE may have at least partially overlapping frequency resources reserved by the one or more other UEs.

At block 710, the method 700 may include performing, at the first UE, a listen-before-talk (LBT) procedure prior to initiating transmission from the first UE to the second UE. In some examples, the method of block 710 may be performed by processor 612, the modem 644, the communication management component 198, LBT component 625 and/or one or more other components or subcomponents of the UE 104.

In some examples, the processor 612, the modem 644, the communication management component 198, LBT component 625 and/or one or more other components or subcomponents of the UE 104 may be configured to and/or may define means for performing, at the first UE, a listen-before-talk (LBT) procedure prior to initiating transmission from the first UE to the second UE.

At block 715, the method 700 may include transmitting, from the first UE to the second UE, one or more packets over the plurality of resources selected within the resource selection window based on a successful completion of the LBT procedure. In some aspects, the method of block 715 may be performed by the processor 612, the modem 644, the communication management component 198, the sidelink communication component 630 in conjunction with the transceiver 602 and/or one or more other components or subcomponents of the UE 104.

In some examples, transmitting, from the first UE to the second UE, one or more packets over the plurality of resources may include transmitting the one or more packets with a modification to the selection of the plurality of resources within the resource selection window based on the LBT procedure identifying a resource conflict within the preemption window due to a reservation within the resource selection window by another UE with a higher-priority traffic than the one or more packets scheduled for transmission by the first UE to the second UE. In some examples, the modification to the selection of the plurality of resources includes modifying the one or more packets to accommodate the resource conflict within the preemption window. In some aspects, modifying the one or more packets may comprise generating, at the first UE, a plurality of different versions of the one or more packets to be transmitted prior to the first UE performing the LBT procedure such that the first UE can select one of the different versions of the one or more packets to be transmitted that accommodates the resource conflict.

In some examples, transmitting the one or more packets over the plurality of resources selected within the resource selection window comprises detecting a resource conflict within a COT by the one or more other UEs with a higher-priority transmission than the first UE that have reserved resourced. In some examples, the method may also include abandoning the transmission from the first UE to the second UE at least a T number of slots (e.g., two or more slots) prior to a start of the higher-priority transmission. In some aspects, the method may also signaling a COT sharing of resources from the first UE to the one or more other UEs with the higher-priority transmission that have resources reserved within the COT, and transmitting from the first UE to the second UE the one or more packets over non-overlapping frequency resources with the one or more other UEs. In some aspects, signaling the COT sharing includes identifying within a sidelink control information (SCI) message the destination identification for the first UE

In some examples, the preemption window may be determined based on a per-UE basis or per-reservation basis.

In certain implementations, the processor 612, the modem 644, the communication management component 198, the sidelink communication component 630 in conjunction with the transceiver 602 and/or one or more other components or subcomponents of the UE 104 may be configured to and/or may define means for transmitting, from the first UE to the second UE, one or more packets over the plurality of resources selected within the resource selection window based on a successful completion of the LBT procedure.

### SOME FURTHER EXAMPLE CLAUSES

Implementation examples are described in the following numbered clauses:
1. A method for wireless communication, comprising:
   selecting a plurality of resources within a resource selection window for communication from a first user equipment (UE) to a second UE. The plurality of resources may be selected within the resource selection window to allow one or more other UEs with a higher-priority transmission than the first UE to gain access to the shared channel. And the plurality of resources selected by the first UE may have at least partially overlapping frequency resources reserved by the one or more other UEs;
   performing, at the first UE, a listen-before-talk (LBT) procedure prior to initiating transmission from the first UE to the second UE; and
   transmitting, from the first UE to the second UE, one or more packets over the plurality of resources selected within the resource selection window based on a successful completion of the LBT procedure.
2. The method of clause 1, wherein the plurality of resources within the resource selection window are selected such that a first starting time for transmission by the first UE to the second UE and a second starting time for the higher-priority transmission by the one or more additional UEs in the shared channel is no earlier than a slot.
3. The method of any of the preceding clauses, wherein the plurality of resources within the resource selection window are selected such that a first starting time for transmission by the first UE to the second UE and a second starting time for the higher-priority transmission by the one or more additional UEs in the shared channel is aligned within a slot.
4. The method of any of the preceding clauses, wherein transmitting the one or more packets over the plurality of resources selected within the resource selection window based on a successful completion of the LBT procedure comprises:
   transmitting the one or more packets with a modification to the selection of the plurality of resources within the resource selection window based on the LBT procedure identifying an overlapping frequency resource conflict due to a reservation by another UE with a higher-priority traffic than the one or more packets scheduled for transmission by the first UE to the second UE.
5. The method of any of the preceding clauses, wherein the modification to the selection of the plurality of resources includes modifying the one or more packets to accommodate the resource conflict within the preemption window.
6. The method of any of the preceding clauses, wherein modifying the one or more packets comprises:
   generating, at the first UE, a plurality of different versions of the one or more packets to be transmitted prior to the first UE performing the LBT procedure such that the first UE can select one of the different versions of the one or more packets to be transmitted that accommodates the resource conflict.
7. The method of any of the preceding clauses, wherein the partially overlapping frequency resources includes one or both of overlapping LBT bandwidth needed by the one or more other UEs to complete the LBT procedure or overlapping subchannels as the plurality of resources selected by the first UE.
8. The method of any of the preceding clauses, wherein selecting the plurality of resources within the resource selection window for communication from the first UE to the second UE includes selecting a sub-slot transmission starting point for the plurality of resources selected by the first UE.
9. The method of any of the preceding clauses, wherein the at least partially overlapping frequency resources reserved by the one or more other UEs indicates a sub-slot transmission starting point.
10. The method of any of the preceding clauses, wherein transmitting the one or more packets over the plurality of resources selected within the resource selection window comprises:
   detecting a resource conflict within a channel occupancy time (COT) by the one or more other UEs with a higher-priority transmission than the first UE that have reserved resourced.
11. The method of any of the preceding clauses, further comprising:
   abandoning the transmission from the first UE to the second UE at least a T number of slots prior to a start of the higher-priority transmission.
12. The method of any of the preceding clauses, further comprising:
   signaling a COT sharing of resources from the first UE to the one or more other UEs with the higher-priority transmission that have resources reserved within the COT; and
   transmitting from the first UE to the second UE the one or more packets over non-overlapping frequency resources with the one or more other UEs.
13. The method of any of the preceding clauses, wherein signaling the COT sharing includes identifying within a sidelink control information (SCI) message the destination identification for the first UE.
14. The method of any of the preceding clauses, wherein the at least partially overlapping frequency resources reserved by the one or more other UEs is within T slots of the plurality of resources selected by the first UE, wherein a value of T is determined based on a per-UE basis or per-reservation basis.
15. An apparatus for wireless communication by a first user equipment (UE), comprising:
   a memory; and
   a processor coupled with the memory and configured to:
   select a plurality of resources within a resource selection window for communication from the first UE to a second UE, wherein the plurality of resources are selected within the resource selection window to allow one or more other UEs with a higher-priority transmission than the first UE to gain access to the shared channel, and wherein the plurality of resources selected by the first UE have at least partially overlapping frequency resources reserved by the one or more other UEs;
   perform, at the first UE, a listen-before-talk (LBT) procedure prior to initiating transmission from the first UE to the second UE; and
   transmit, from the first UE to the second UE, one or more packets over the plurality of resources selected within the resource selection window based on a successful completion of the LBT procedure.
16. The apparatus of clause 15, wherein the plurality of resources within the resource selection window are selected such that a first starting time for transmission by the first UE to the second UE and a second starting time for the higher-priority transmission by the one or more additional UEs in the shared channel is no earlier than a slot.
17. The apparatus of any of the preceding clauses, wherein the plurality of resources within the resource selection window are selected such that a first starting time for transmission by the first UE to the second UE and a second starting time for the higher-priority transmission by the one or more additional UEs in the shared channel is aligned within a slot.
18. The apparatus of any of the preceding clauses, wherein the processor configured to transmit the one or more packets over the plurality of resources selected within the resource selection window based on a successful completion of the LBT procedure is further configured to:
   transmit the one or more packets with a modification to the selection of the plurality of resources within the resource selection window based on the LBT procedure identifying an overlapping frequency resource conflict due to a reservation by another UE with a higher-priority traffic than the one or more packets scheduled for transmission by the first UE to the second UE.
19 The apparatus of any of the preceding clauses, wherein the modification to the selection of the plurality of resources includes modifying the one or more packets to accommodate the resource conflict within the preemption window.
20. The apparatus of any of the preceding clauses, wherein the processor configured to modify the one or more packets is further configured to:
   generate, at the first UE, a plurality of different versions of the one or more packets to be transmitted prior to the first UE performing the LBT procedure such that the first UE can select one of the different versions of the one or more packets to be transmitted that accommodates the resource conflict.
21. The apparatus of any of the preceding clauses, wherein the partially overlapping frequency resources includes one or both of overlapping LBT bandwidth needed by the one or more other UEs to complete the LBT procedure or overlapping subchannels as the plurality of resources selected by the first UE.
22. The apparatus of any of the preceding clauses, wherein selecting the plurality of resources within the resource selection window for communication from the first UE to the second UE includes selecting a sub-slot transmission starting point for the plurality of resources selected by the first UE.
23. The apparatus of any of the preceding clauses, wherein the at least partially overlapping frequency resources reserved by the one or more other UEs indicates a sub-slot starting point.
24. The apparatus of any of the preceding clauses, wherein the processor configured to transmit the one or more packets over the plurality of resources selected within the resource selection window is further configured to:
   detect a resource conflict within a channel occupancy time (COT) by the one or more other UEs with a higher-priority transmission than the first UE that have reserved resourced.
25 The apparatus of any of the preceding clauses, wherein the processor configured to:
   abandon the transmission from the first UE to the second UE at least a T number of slots prior to a start of the higher-priority transmission.
26. The apparatus of any of the preceding clauses, wherein the processor configured to:
   signal a COT sharing of resources from the first UE to the one or more other UEs with the higher-priority transmission that have resources reserved within the COT; and transmit from the first UE to the second UE the one or more packets over non-overlapping frequency resources with the one or more other UEs.
27. The apparatus of any of the preceding clauses, wherein signaling the COT sharing includes identifying within a sidelink control information (SCI) message the destination identification for the first UE.
28. The apparatus of any of the preceding clauses, wherein the at least partially overlapping frequency resources reserved by the one or more other UEs is within T slots of the plurality of resources selected by the first UE, wherein a value of T is determined based on a per-UE basis or per-reservation basis.
29. A non-transitory computer readable medium storing instructions, executable by a processor, for wireless communications, comprising instructions for:
   selecting a plurality of resources within a resource selection window for communication from a first user equipment (UE) to a second UE, wherein the plurality of resources are selected within the resource selection window to allow one or more other UEs with a higher-priority transmission than the first UE to gain access to the shared channel, and wherein the plurality of resources selected by the first UE have at least partially overlapping frequency resources reserved by the one or more other UEs;
   performing, at the first UE, a listen-before-talk (LBT) procedure prior to initiating transmission from the first UE to the second UE; and
   transmitting, from the first UE to the second UE, one or more packets over the plurality of resources selected within the resource selection window based on a successful completion of the LBT procedure.
30 An apparatus for wireless communications, comprising:
   means for select a plurality of resources within a resource selection window for communication from a first user equipment (UE) to a second UE, wherein the plurality of resources are selected within the resource selection window to allow one or more other UEs with a higher-priority transmission than the first UE to gain access to the shared channel, and wherein the plurality of resources selected by the first UE have at least partially overlapping frequency resources reserved by the one or more other UEs;
   means for performing, at the first UE, a listen-before-talk (LBT) procedure prior to initiating transmission from the first UE to the second UE; and
   means for transmitting, from the first UE to the second UE, one or more packets over the plurality of resources selected within the resource selection window based on a successful completion of the LBT procedure.

While the foregoing disclosure discusses illustrative aspects and/or embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method for wireless communication, comprising:
selecting a plurality of resources within a resource selection window for communication from a first user equipment (UE) to a second UE, wherein the plurality of resources are selected within the resource selection window to allow one or more other UEs with a higher-priority transmission than the first UE to gain access to a shared channel, and wherein the plurality of resources selected by the first UE have at least a partially overlapping frequency resources reserved by the one or more other UEs;
performing, at the first UE, a listen-before-talk (LBT) procedure prior to initiating transmission from the first UE to the second UE; and
transmitting, from the first UE to the second UE, one or more packets over the plurality of resources selected within the resource selection window based on a successful completion of the LBT procedure.

2. The method of claim 1, wherein the plurality of resources within the resource selection window are selected such that a first starting time for transmission by the first UE to the second UE and a second starting time for the higher-priority transmission by the one or more other UEs in the shared channel is no earlier than a slot.

3. The method of claim 1, wherein the plurality of resources within the resource selection window are selected such that a first starting time for transmission by the first UE to the second UE and a second starting time for the higher-priority transmission by the one or more other UEs in the shared channel is aligned within a slot.

4. The method of claim 1, wherein transmitting the one or more packets over the plurality of resources selected within the resource selection window based on a successful completion of the LBT procedure comprises:
transmitting the one or more packets with a modification to the selection of the plurality of resources within the resource selection window based on the LBT procedure identifying an overlapping frequency resource conflict due to a reservation by another UE with a higher-priority traffic than the one or more packets scheduled for transmission by the first UE to the second UE.

5. The method of claim 4, wherein the modification to the selection of the plurality of resources includes modifying the one or more packets to accommodate the overlapping frequency resource conflict.

6. The method of claim 5, wherein modifying the one or more packets comprises:
generating, at the first UE, a plurality of different versions of the one or more packets to be transmitted prior to the first UE performing the LBT procedure such that the first UE can select one of the different versions of the one or more packets to be transmitted that accommodates the overlapping frequency resource conflict.

7. The method of claim 1, wherein the partially overlapping frequency resources includes one or both of overlapping LBT bandwidth needed by the one or more other UEs to complete the LBT procedure or overlapping subchannels as the plurality of resources selected by the first UE.

8. The method of claim 1, wherein selecting the plurality of resources within the resource selection window for communication from the first UE to the second UE includes selecting a sub-slot transmission starting point for the plurality of resources selected by the first UE.

9. The method of claim 1, wherein the at least partially overlapping frequency resources reserved by the one or more other UEs indicates a sub-slot transmission starting point.

10. The method of claim 1, wherein transmitting the one or more packets over the plurality of resources selected within the resource selection window comprises:
detecting a resource conflict within a channel occupancy time (COT) by the one or more other UEs with a higher-priority transmission than the first UE that have reserved resourced.

11. The method of claim 10, further comprising:
abandoning the transmission from the first UE to the second UE at least a T number of slots prior to a start of the higher-priority transmission.

12. The method of claim 10, further comprising:
signaling a COT sharing of resources from the first UE to the one or more other UEs with the higher-priority transmission that have resources reserved within the COT; and
transmitting from the first UE to the second UE the one or more packets over non-overlapping frequency resources with the one or more other UEs.

13. The method of claim 12, wherein signaling the COT sharing includes identifying within a sidelink control information (SCI) message a destination identification for the first UE.

14. The method of claim 1, wherein the at least partially overlapping frequency resources reserved by the one or more other UEs is within T slots of the plurality of resources selected by the first UE, wherein a value of T is determined based on a per-UE basis or per-reservation basis.

15. An apparatus for wireless communication by a first user equipment (UE), comprising:
a memory; and
a processor coupled with the memory and configured to:
select a plurality of resources within a resource selection window for communication from the first UE to a second UE, wherein the plurality of resources are selected within the resource selection window to allow one or more other UEs with a higher-priority transmission than the first UE to gain access to a shared channel, and wherein the plurality of resources selected by the first UE have at least a partially overlapping frequency resources reserved by the one or more other UEs;
perform, at the first UE, a listen-before-talk (LBT) procedure prior to initiating transmission from the first UE to the second UE; and
transmit, from the first UE to the second UE, one or more packets over the plurality of resources selected within the resource selection window based on a successful completion of the LBT procedure.

16. The apparatus of claim 15, wherein the plurality of resources within the resource selection window are selected such that a first starting time for transmission by the first UE to the second UE and a second starting time for the higher-priority transmission by the one or more other UEs in the shared channel is no earlier than a slot.

17. The apparatus of claim 15, wherein the plurality of resources within the resource selection window are selected such that a first starting time for transmission by the first UE to the second UE and a second starting time for the higher-priority transmission by the one or more other UEs in the shared channel is aligned within a slot.

18. The apparatus of claim 15, wherein the processor configured to transmit the one or more packets over the plurality of resources selected within the resource selection window based on a successful completion of the LBT procedure is further configured to:
transmit the one or more packets with a modification to the selection of the plurality of resources within the resource selection window based on the LBT procedure identifying an overlapping frequency resource conflict due to a reservation by another UE with a higher-priority traffic than the one or more packets scheduled for transmission by the first UE to the second UE.

19. The apparatus of claim 18, wherein the modification to the selection of the plurality of resources includes modifying the one or more packets to accommodate the overlapping frequency resource conflict.

20. The apparatus of claim 19, wherein the processor configured to modify the one or more packets is further configured to:
generate, at the first UE, a plurality of different versions of the one or more packets to be transmitted prior to the first UE performing the LBT procedure such that the first UE can select one of the different versions of the one or more packets to be transmitted that accommodates the overlapping frequency resource conflict.

21. The apparatus of claim 15, wherein the partially overlapping frequency resources includes one or both of overlapping LBT bandwidth needed by the one or more other UEs to complete the LBT procedure or overlapping subchannels as the plurality of resources selected by the first UE.

22. The apparatus of claim 15, wherein selecting the plurality of resources within the resource selection window for communication from the first UE to the second UE includes selecting a sub-slot transmission starting point for the plurality of resources selected by the first UE.

23. The apparatus of claim 15, wherein the at least partially overlapping frequency resources reserved by the one or more other UEs indicates a sub-slot starting point. 24 The apparatus of claim 15, wherein the processor configured to transmit the one or more packets over the plurality of resources selected within the resource selection window is further configured to:
detect a resource conflict within a channel occupancy time (COT) by the one or more other UEs with a higher-priority transmission than the first UE that have reserved resourced.

25. The apparatus of claim 24, wherein the processor configured to:
abandon the transmission from the first UE to the second UE at least a T number of slots prior to a start of the higher-priority transmission.

26. The apparatus of claim 24, wherein the processor configured to:
signal a COT sharing of resources from the first UE to the one or more other UEs with the higher-priority transmission that have resources reserved within the COT; and
transmit from the first UE to the second UE the one or more packets over non-overlapping frequency resources with the one or more other UEs.

27. The apparatus of claim 26, wherein signaling the COT sharing includes identifying within a sidelink control information (SCI) message a destination identification for the first UE.

28. The apparatus of claim 15, wherein the at least partially overlapping frequency resources reserved by the one or more other UEs is within T slots of the plurality of resources selected by the first UE, wherein a value of T is determined based on a per-UE basis or per-reservation basis.

29. A non-transitory computer readable medium storing instructions, executable by a processor, for wireless communications, comprising instructions for:
selecting a plurality of resources within a resource selection window for communication from a first user equipment (UE) to a second UE, wherein the plurality of resources are selected within the resource selection window to allow one or more other UEs with a higher-priority transmission than the first UE to gain access to a shared channel, and wherein the plurality of resources selected by the first UE have at least a partially overlapping frequency resources reserved by the one or more other UEs;
performing, at the first UE, a listen-before-talk (LBT) procedure prior to initiating transmission from the first UE to the second UE; and
transmitting, from the first UE to the second UE, one or more packets over the plurality of resources selected within the resource selection window based on a successful completion of the LBT procedure.

30. An apparatus for wireless communications, comprising:
means for select a plurality of resources within a resource selection window for communication from a first user equipment (UE) to a second UE, wherein the plurality of resources are selected within the resource selection window to allow one or more other UEs with a higher-priority transmission than the first UE to gain access to a shared channel, and wherein the plurality of resources selected by the first UE have at least a partially overlapping frequency resources reserved by the one or more other UEs;
means for performing, at the first UE, a listen-before-talk (LBT) procedure prior to initiating transmission from the first UE to the second UE; and
means for transmitting, from the first UE to the second UE, one or more packets over the plurality of resources selected within the resource selection window based on a successful completion of the LBT procedure.
